(19) United States
(12) Patent Application Publication
(10) Pub. No.: US 2024/0396767 A1
(43) Pub. Date: Nov. 28, 2024

(54) MACHINE LEARNING BASED CHANNEL ESTIMATION FOR AN ANTENNA ARRAY

(71) Applicant: Nokia Solutions and Networks Oy, Espoo (FI)

(72) Inventors: Yejian CHEN, Stuttgart (DE); Jafar MOHAMMADI, Stuttgart (DE); Stefan WESEMANN, Kornwestheim (DE); Thorsten WILD, Stuttgart (DE)

(73) Assignee: Nokia Solutions and Networks Oy, Espoo (FI)

(21) Appl. No.: 18/696,159

(22) PCT Filed: Oct. 7, 2021
(86) PCT No.: PCT/EP2021/077728

§ 371 Date: Mar. 27, 2024

(51) Int. Cl. H04L 25/02

(52) U.S. Cl. CPC H04L 25/0254; H04L 25/0204; H04L 25/0232

(57) ABSTRACT

A method of channel estimation for a receiver side antenna array includes receiving a first signal associated with a pilot tone transmitted by a transmitter side antenna array, obtaining a first group of neural network models trained for channel estimation based on the pilot tone, inputting a representation of the received first signal into each neural network model of the first group, performing one-dimensional interpolation for second signals associated with data tones in at least one of time domain and frequency domain, obtaining a second group of neural network models trained for channel estimation in presence of interpolation errors based on the data tones, and for each one-dimensional interpolation, inputting an interpolated channel estimate of the generated interpolated channel estimates into each neural network model of the second group and generating a corrected interpolated channel estimate for a second signal.

### TECHNICAL FIELD

At least some example embodiments relate to machine learning based channel estimation for an antenna array.

### BACKGROUND

Recently, Artificial Intelligence (AI) based technologies have impacted the research and innovation of many scientific branches, exploiting Machine Learning (ML) or Deep Learning (DL) with Neural Networks (NN). In wireless communications, the AI based technologies provide complementary solutions for blind channel decoding, data detection, modulation recognition, channel estimation, and many others, which can be regarded as potential features of 5G or even B5G systems.

Accurate channel estimation is a key technical prerequisite for data estimation. The objective of channel estimation is to extract the channel vector ‘H’ from a received signal vector ‘Y’ in order to accurately decode a transmitted data signal ‘X’. For example, in order to get channel estimates for data tones, interpolation in time and frequency is required. With the increased mobility, interpolation becomes a very challenging problem.

### LIST OF REFERENCES

[1] Yejian Chen; Jafar Mohammadi; Stefan Wesemann; Thorsten Wild; “Turbo-AI based Channel Estimation for Massive MIMO Antenna Panel with Low Complexity Subspace Training,” PCT/EP2021/062275, filed on May 10, 2021.
[2] Yejian Chen; Jafar Mohammadi; Stefan Wesemann; Thorsten Wild; “Turbo-AI, Part I: Iterative Machine Learning Based Channel Estimation for 2D Massive Arrays,” accepted by 2021 IEEE 93rd Veh. Technol. Conf. (VTC'21 Spring), Helsinki, Finland, April 2021.
[3] Yejian Chen; Jafar Mohammadi; Stefan Wesemann; Thorsten Wild; “Turbo-AI, Part II: Multi-Dimensional Iterative ML-Based Channel Estimation for B5G,” accepted by 2021 IEEE 93rd Veh. Technol. Conf. (VTC'21 Spring), Helsinki, Finland, April 2021.
[4] Erik Dahlman; Stefan Parkvall; Johan Skold; “5G NR: The Next Generation Wireless Access Technology,” Academic Press, ISBN: 978-0-12-814323-0, August 2018.

### LIST OF ABBREVIATIONS

5G Fifth Generation
6G Sixth Generation
B5G Beyond 5G
AI Artificial Intelligence
CDM Code Division Multiplexing
DL Deep Learning
DNN Dense Neural Network
DMRS Demodulation Reference Signals
LLR Log-Likelihood-Ratio
ML Machine Learning
MSE Mean Square Error
NN Neural Network
PDF Probability Density Function
PRB Physical Resource Block
RE Resource Element
SRS Sounding Reference Signal

### SUMMARY

At least some example embodiments provide for channel estimation (e.g. DMRS-based channel estimation) for an antenna array with machine learning aided universal interpolation for high mobility.

Further, at least some example embodiments provide for enhanced channel estimation (e.g. DMRS-based channel estimation) for an antenna array with machine learning aided universal interpolation for ultra-high mobility.

According to at least some example embodiments, a method of channel estimation, an apparatus for channel estimation and a non-transitory computer-readable storage medium are provided as specified by the appended claims.

In the following example embodiments and example implementations will be described with reference to the accompanying drawings.

### BRIEF DESCRIPTION OF THE DRAWINGS

FIG. 1 shows a schematic diagram illustrating DMRS and data pattern of single layer communications.

FIG. 2 shows a flow diagram illustrating a first example implementation of a DMRS-Turbo-AI according to at least some example embodiments.

FIG. 3 shows a flow diagram illustrating a second example implementation of a DMRS-Turbo-AI according to at least some example embodiments.

FIG. 4 shows a flowchart illustrating a method of channel estimation according to at least some example embodiments.

FIG. 5 shows a diagram illustrating performance of a conventional Turbo-AI and a DMRS-Turbo-AI according to at last some example embodiments, with diverse options for user mobility.

FIG. 6 shows a schematic diagram illustrating modified DMRS and data pattern of single layer communications according to at least some example embodiments.

FIG. 7 shows a schematic diagram illustrating one data pattern in frequency and spatial domains.

FIG. 8 shows a schematic block diagram illustrating introduction of virtual pilots for DMRS-Turbo-AI according to at least some example embodiments.

FIG. 9 shows a schematic diagram illustrating inner loops in Firecracker Algorithm according to at least some example embodiments.

FIG. 10 illustrates a schematic block diagram illustrating a universal NN model to realize the Firecracker Algorithm according to at least some example embodiments.

FIG. 11 shows a schematic diagram illustrating a virtual pilot detection order and a final correction in time domain according to at least some example embodiments.

FIG. 12 shows a flowchart illustrating a method of channel estimation according to at least some example embodiments.

FIG. 13 shows a diagram illustrating how the Firecracker Algorithm improves channel estimation MSE in accordance with a detection order.

FIG. 14 shows a diagram illustrating performance of the DMRS-Turbo-AI with Firecracker Algorithm according to at least some example embodiments.

FIG. 15 shows a schematic diagram illustrating modified DMRS and data pattern of two-layer communications according to at least some example embodiments.

FIG. 16 shows a schematic block diagram illustrating a configuration of a control unit in which at least some example embodiments are implementable.

### DESCRIPTION OF THE EMBODIMENTS

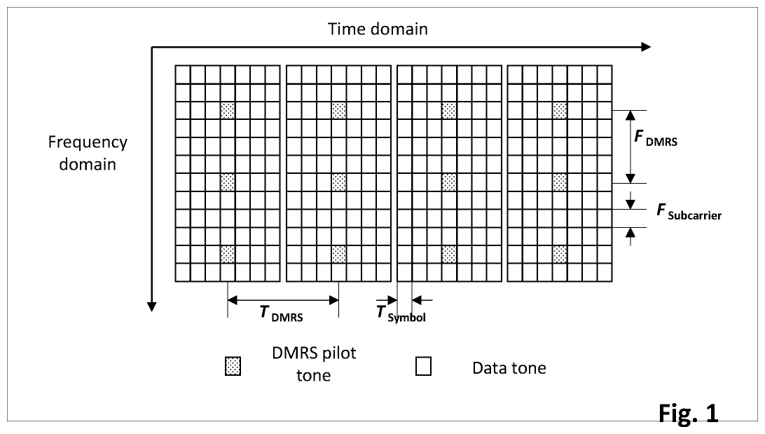

NN-based iterative channel estimation concept Turbo-AI is described in above-listed references [1]-[3]. References [1]-[3] demonstrate applicability of Turbo-AI to de-noise received pilots in an iterative ML-based approach, especially for Sounding Reference Signal (SRS), which is usually responsible for estimating 2nd order channel statistics, or supporting certain control mechanisms. While, if DMRS-based channel estimation, which is responsible for supporting data estimation, is focused on, it is noticed that the DMRSs are discrete pilots within a two-dimensional frequency-time grid, as illustrated in FIG. 1 (which will be described in more detail later on). Therefore, in order to get the channel estimates for data tones, interpolation in time and frequency is required. With the increased mobility, interpolation becomes a very challenging problem.

According to conventional communication theory, interpolation should be carried out within the coherent time and coherent bandwidth of the wireless channel, as the metrics for time domain and frequency domain, respectively, in order to guarantee and reach certain estimation accuracy. Here, the channel estimation problem is tackled for users with high to ultra-high mobility, typically 300 km/h-500 km/h, with help of machine learning.

At least some example embodiments to be described in more detail later on provide for a solution as ML-based channel estimation for users with ultra-high mobility through TWO paths. A short summary of Path A and Path B will be given below.

Path A: An evolved Turbo-AI architecture is exploited for DMRS-based channel estimation, referred to as DMRS-Turbo-AI throughout this application. After carrying out interpolation in time/frequency domain, one or more extra NNs for conventional Turbo-AI are inserted, which are dedicatedly trained for recognizing and correcting interpolation errors as post-processing. After introducing these NNs to perform the interpolation correction, the performance of DMRS-Turbo-AI can quite closely approach the performance of conventional Turbo-AI, in which channel response is uniquely estimated from pilot tones. Concluded from simulations, DMRS-Turbo-AI is able to deliver robust performance for users with high mobility up to 250 km/h.

Path B: In order to support data communications for users with ultra-high mobility, a user data pattern is changed, which facilitates to treat certain data tones between two consecutive DMRS symbols as virtual pilots. Furthermore, an interpolation scheme, named as Firecracker Algorithm, is proposed, which does not significantly depend on the user mobility, can guarantee sufficient interpolation quality, and thus can be regarded as a universal interpolation scheme. The data-aided pilot acquisition will straightforwardly improve the interpolation. If being combined with DMRS-Turbo-AI, further performance boost can be achieved, for supporting the data detection for users with ultra-high mobility up to 500 km/h, even beyond 1000 km/h. Considering further standard compliant classification with respect to potential impact on pilot/data framework of 6G communications, Path B can be distinguished into two subcases.

Subcase B1: Single layer transmission, where just virtual pilots and rank-1 transmission are used and no standards change is needed.

Subcase B2: MIMO transmission, where virtual pilots can be used on one layer and the other layer(s) are blank or the virtual pilots share the same data tone, protected by Code Division Multiplexing (CDM) with spreading/de-spreading operations or resolvable by multiuser detector, which requires standards change.

Before describing details of Path A and Path B according to at least some example embodiments, it is noted that, in at least some example embodiments, two-step NNs for an MMSE-inspired de-noising are used as 1D-NN based channel estimators, and conventional Turbo-AI is adopted as described in references [1]-[3], exploiting these 1D-NN based channel estimators through frequency, time and spatial domains.

According to at least some example embodiments to be described in more detail later on:
I. Additional NNs are trained and inserted to conventional Turbo-AI to correct interpolation errors, referred to as DMRS-Turbo-AI.
II. For ultra-high mobility scenario, virtual pilots are exploited to perform data-aided channel estimation, based on the estimates from spatial domain, which is free of interpolation, and based on Firecracker Algorithm to guarantee high interpolation quality in time domain.
III. The data pattern is modified to support virtual pilots for single-user and multi-user scenarios with DMRS-Turbo-AI.

### Path A

FIG. 1 illustrates quantitatively a data pattern of a single layer DMRS and data transmission. In reference [4], more standard compliant DMRS configurations can be referred to. It is noted that the spatial domain is not illustrated in FIG. 1. Regarding the spatial domain it has to be imagined that the same data pattern will be spatially received as multiple copies.

In FIG. 1, DMRS pilot tones are shown which are repeated with (have an interval of) T_{DMRS} and F_{DMRS}. Further, data tones are shown which are repeated with (have an interval of) T_{symbol} and F_{subcarrier}.

Conventional Turbo-AI as described in references [1]-[3] focuses on ML-based channel estimation ONLY for the noisy pilot tones, by means of iterations through frequency/time/horizontal/vertical domains consecutively.

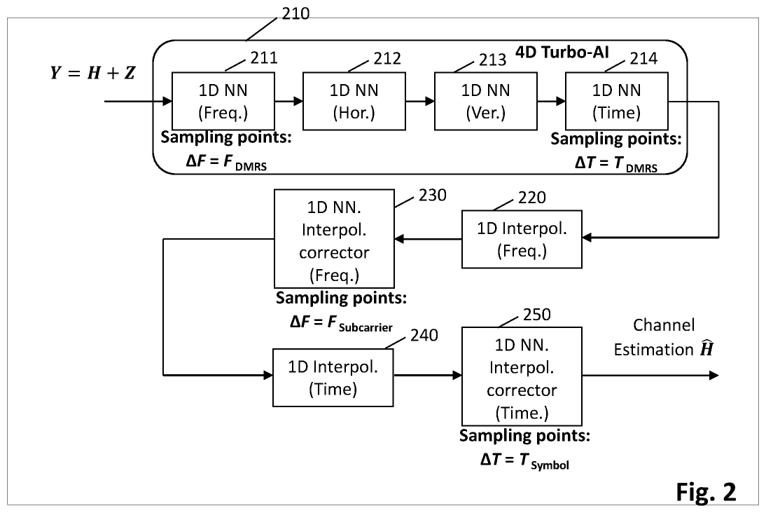

In order to make Turbo-AI adapt to DMRS-based channel estimation, modifications need to be taken into account, as presented in FIG. 2.

In FIG. 2, the flow diagram of DMRS-Turbo-AI according to at least some example embodiments is presented. A 4D Turbo-AI 210 is based on conventional Turbo-AI as described in references [1]-[3]. The 4D Turbo-AI processing 210 comprises a group of 1D NNs 211, 212, 213 and 214 for frequency domain, horizontal domain, vertical domain and time domain, respectively. Sampling points in frequency domain are spaced apart by ΔF=F_{DMRS}, and in time domain by ΔT=T_{DMRS}.

To be more precise, signal Y is a four-dimensional (4D) tensor signal which is associated with a pilot tone (e.g. DMRS pilot tone) transmitted by an antenna array on a transmitter side (also referred to in the following as “transmitter side antenna array”). The signal Y is received by an antenna array on a receiver side (also referred to in the following as “receiver side antenna array”).

As described in more detail in references [1]-[3], the signal Y (the 4D tensor) is projected to 1D data y_{f} for frequency domain which is input into 1D NN 211 which was trained for channel estimation in frequency domain using signals associated with the pilot tone and a correct channel estimate for frequency domain h_{f} as label. The 1D NN 211 outputs a channel estimate h_{f\hat{ }} for frequency domain. Then, the 1D data is transformed back to the 4D tensor.

Subsequently, the 4D tensor is projected to 1D data yₕ for horizontal domain which is input into 1D NN 212 which was trained for channel estimation in horizontal domain using signals associated with the pilot tone and a correct channel estimate for horizontal domain hₕ as label. The 1D NN 212 outputs a channel estimate h_{h\hat{ }} for horizontal domain. Then, the 1D data is transformed back to the 4D tensor.

Subsequently, the 4D tensor is projected to 1D data yᵥ for vertical domain which is input into 1D NN 213 which was trained for channel estimation in vertical domain using signals associated with the pilot tone and a correct channel estimate for vertical domain hᵥ as label. The 1D NN 213 outputs a channel estimate h_{v\hat{ }} for vertical domain. Then, the 1D data is transformed back to the 4D tensor.

Subsequently, the 4D tensor is projected to 1D data yₜ for time domain which is input into 1D NN 214 which was trained for channel estimation in time domain using signals associated with the pilot tone and a correct channel estimate for time domain hₜ as label. The 1D NN 214 outputs a channel estimate h_{t\hat{ }} for time domain.

Finally, a channel estimate for the signal Y is output from the 4D Turbo-AI 210.

After exploiting the 4D Turbo-AI 210 for the pilot tones (DMRSs) Y=H+Z, one-dimensional interpolation 220, 240 is carried out for data tones in frequency domain and time domain consecutively. After each interpolation 220, 240, a one-dimensional NN 230, 250 is trained, based on a new observation obtained by the interpolation, the new observation including an interpolation error. With the clean label (correct channel estimate) H, the one-dimensional NN 230, 250 serves as a corrector, in order to learn the behavior of interpolation error. Finally, according to at least some example embodiments, one-dimensional NNs in horizontal and vertical domains (not shown in FIG. 2) are exploited to correct the channel estimation H\hat{ } output from the 1D NN interpolation corrector 250 in spatial domain independently.

It is noted that in 1D NN interpolation corrector for frequency domain 230 1D NN interpolation corrector for time domain 250, sampling points in frequency domain are spaced apart by ΔF=F_{subcarrier}, and in time domain by ΔT=T_{symbol}.

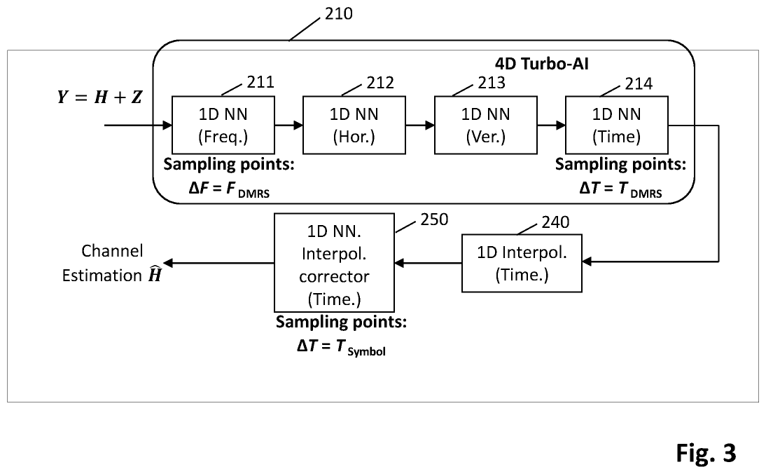

In the following description, interpolation in time domain is focused on, since the high mobility scenario will majorly impact the interpolation in time domain than in frequency domain. Thus, according to at least some example embodiments, DMRS-Turbo-AI configuration with one-dimensional interpolation in time domain is adopted, as shown in FIG. 3.

In other words, the DMRS-Turbo-AI configuration of FIG. 3 corresponds to that of FIG. 2 except for omitting the 1D interpolation 220 in frequency domain and its 1D NN interpolation corrector 230.

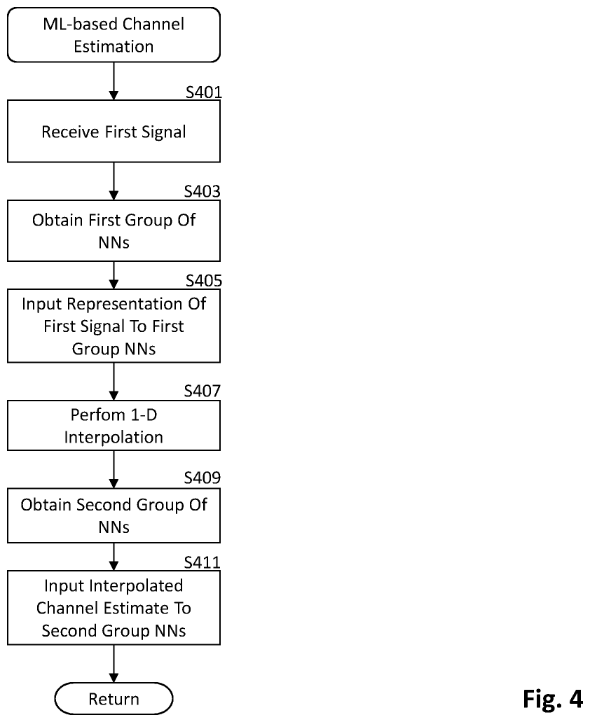

Now reference is made to FIG. 4 illustrating a process of ML-based channel estimation for a receiver side antenna array according to at least some example embodiments. After start of the process, the process proceeds to step S401. For example, the process is started when

In step S401, a first signal associated with a pilot tone transmitted by a transmitter side antenna array is received. For example, the first signal is the signal Y=H+Z as shown in FIGS. 2 and 3. Then, the process proceeds to step S403.

In step S403, a first group of neural network models trained for channel estimation using signals associated with the pilot tone is obtained. For example, the 1D NNs 211 to 214 shown in FIGS. 2 and 3 are obtained. Then, the process proceeds to step S405.

In step S405, a representation of the received first signal is input into each neural network model of the first group and a channel estimate for the received first signal is generated. For example, the channel estimate for the received first signal corresponds to an output from the 4D Turbo-AI 210. Then, the process proceeds to step S407.

In step S407, based on the channel estimate for the received first signal, one-dimensional interpolation for second signals associated with data tones in at least one of time domain and frequency domain is performed, thereby generating interpolated channel estimates for the second signals, which include interpolation errors. For example, the interpolations are performed by the 1D interpolations 220, 240 which output the interpolated channel estimates for the second signals. Then, the process proceeds to step S409.

In step S409, a second group of neural network models trained for channel estimation in presence of interpolation errors using signals associated with the data tones is obtained. For example, these neural network models of the second group comprise the 1D NNs for spatial domain for correcting the output from the 1D interpolations 220, 240 in spatial domain.

According to at least some example embodiments to be described in connection with the description of Path B, the neural network models of the second group comprise 1D NNs for frequency and spatial domains for correcting the output from the 1D interpolator 240 of FIG. 3 in frequency and spatial domains.

Then, the process proceeds to step S411.

In step S411, for each one-dimensional interpolation, an interpolated channel estimate of the generated interpolated channel estimates is input into each neural network model of the second group, and a corrected interpolated channel estimate for a second signal is generated. According to at least some example embodiments, the corrected interpolated channel estimate corresponds to a channel estimation H\hat{ } output from the above-mentioned 1D NNs for spatial domain.

Alternatively, according to at least some example embodiments to be described in connection with the description of Path B, the corrected interpolated channel estimate corresponds to a channel estimation output from the above-mentioned 1D NNs for frequency and spatial domains for correcting the output from the 1D interpolator 240 of FIG. 3.

Then, the process returns e.g. to receiving a next pilot signal.

Although the interpolation does not add new information, the interpolated channel response, after being reshaped in time, horizontal, vertical domains consecutively, will be corrected in these domains individually, because these 1D NN models are trained, based on known statistics of these domains. In simulations, it is observed that channel estimation quality can be step by step improved, especially at low SNR.

Compared to an NN which carries out interpolation itself, the NN-based corrector (1D NN interpolation corrector) 230, 250 has a complexity which is affordable, by correcting X outputs based on X inputs. In addition, the NN-based interpolation corrector 230, 250 is able to deliver robust performance.

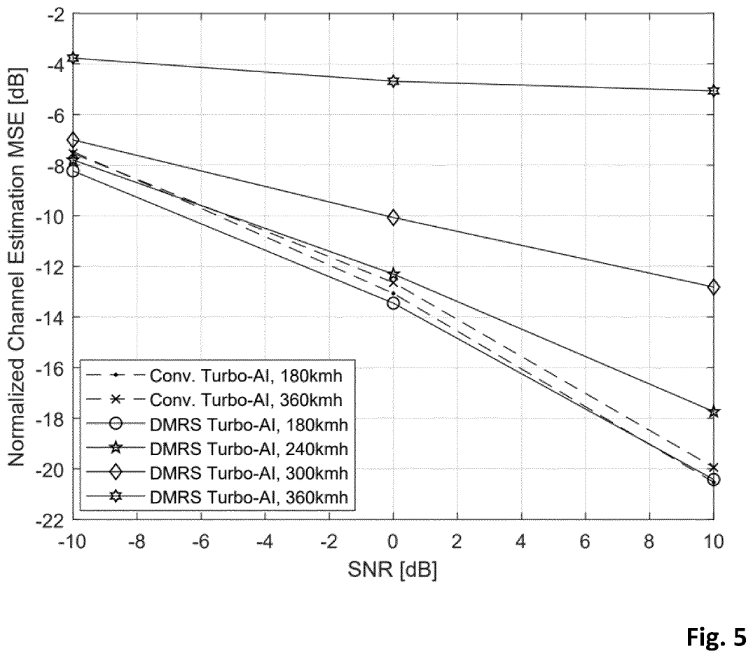

In FIG. 5, as a short summary, the performance of conventional Turbo-AI and DMRS Turbo-AI is listed with diverse options to user mobility. First of all, notice that the conventional Turbo-AI for pilot tones delivers similar performance for users with 180 km/h and 360 km/h. The difference comes from the (relative) increased DMRS interval in 360 km/h case, which reduces the correlation in time domain and causes slight performance degradation. Then, the DMRS-Turbo-AI as depicted in FIG. 3 is exploited for the cases 180 km/h, 240 km/h, 300 km/h and 360 km/h, individually. It is realized that DMRS-Turbo-AI under 180 km/h even outperforms conventional Turbo-AI. As a matter of fact, this should even be a typical effect for users with low mobility, because the data will be processed on consecutive symbol level (in DMRS-Turbo-AI) after high quality interpolation, instead of DMRS pilot interval level (in conventional Turbo-AI), and such outperformance should be expected. Furthermore, DMRS-Turbo-AI still delivers robust performance for 240 km/h case with acceptable degradation, especially at low SNR region. If the user mobility is further increased, the degradation is obvious.

As described above, Path A of DMRS-Turbo-AI fulfills ML-based interpolation correction for users with mobility up to 250 km/h approximately (with 15 kHz subcarrier spacing and 0.5 ms DMRS spacing).

### Path B

In order to support the use case for ultra-high mobility, a slight change for user data pattern is introduced.

### Subcase B1

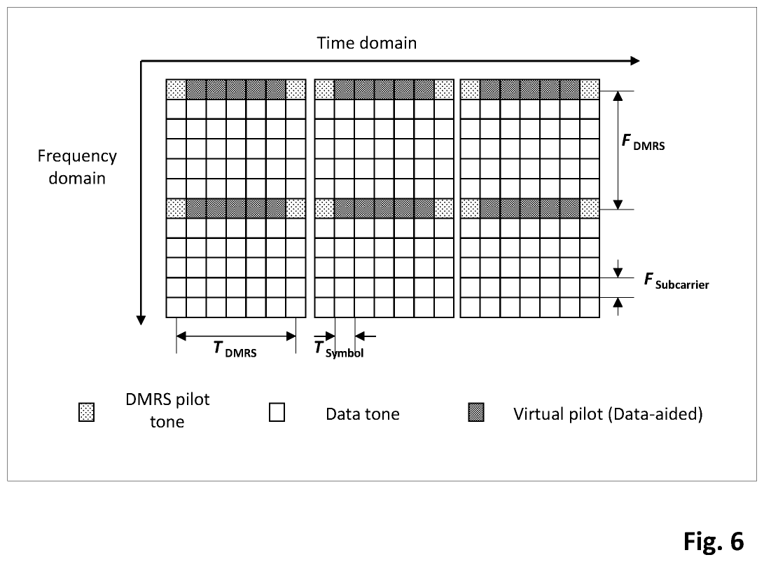

FIG. 6 illustrates modified DMRS and data pattern of single layer communications. A virtual pilot tone is introduced, which is unknown data.

Nevertheless, the special characteristics in spatial domain are utilized to pre-process and estimate this data with existing NN-models in 4D Turbo-AI, and treat the reliable estimate as data-aided virtual pilot. Thus, with additional virtual pilots as “bridges” of interpolation, the ML-based interpolation corrector 230, 250 can again deliver robust performance for ultra-high mobility scenario.

As shown in FIG. 6, the DMRS pilot tones are arranged in a different manner compared to the time-frequency grid of FIG. 1. In between DMRS pilot tones in time domain within one frame, virtual pilot tones are introduced.

For a given time instant, let a received signal be described as

$$y = h ⊙ s + z \qquad ( 1 )$$

where y, h and s denote the F×1 vectors, representing received observation, channel vector and unknown symbols, modulated according to finite constellations, over F consecutive subcarriers. The operator ⊙ denotes Hadamard product (i.e. element-wise multiplication).

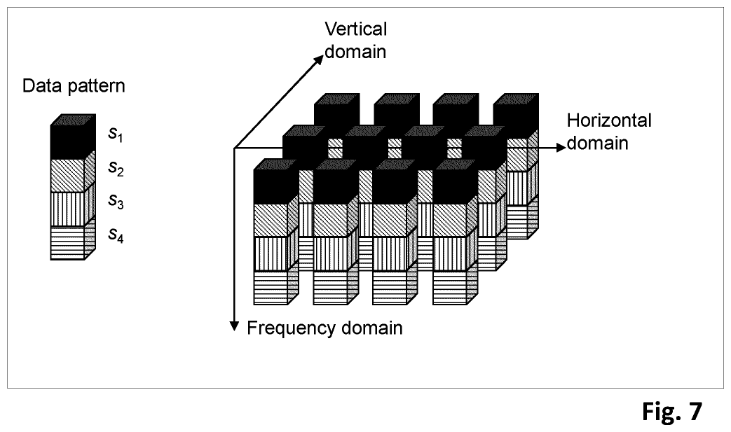

FIG. 7 shows a representation of one data pattern in frequency and spatial domains.

Considering the horizontal and the vertical spatial domains, the covariance matrices of an individual data symbol are

$${R}_{h , s} = E [ {s}_{i} {{h}_{h} ( {s}_{i} {h}_{h} )}^{H} ] = {\vert {s}_{i} \vert}^{2} {R}_{h} = {R}_{h} \qquad ( 2 a )$$

$${R}_{v , s} = E [ {s}_{i} {{h}_{v} ( {s}_{i} {h}_{v} )}^{H} ] = {\vert {s}_{i} \vert}^{2} {R}_{v} = {R}_{v} \qquad ( 2 b )$$

This means that the pre-trained 1D NNs in horizontal and vertical domains can be used, if the virtual pilots are with unity magnitude. It is true that it is not possible to explicitly estimate the data sᵢ, but estimating sᵢhₕ and sᵢhᵥ with the existing 1D NN-models, respectively, is possible. This operation does not depend on interpolation and can reach certain precision.

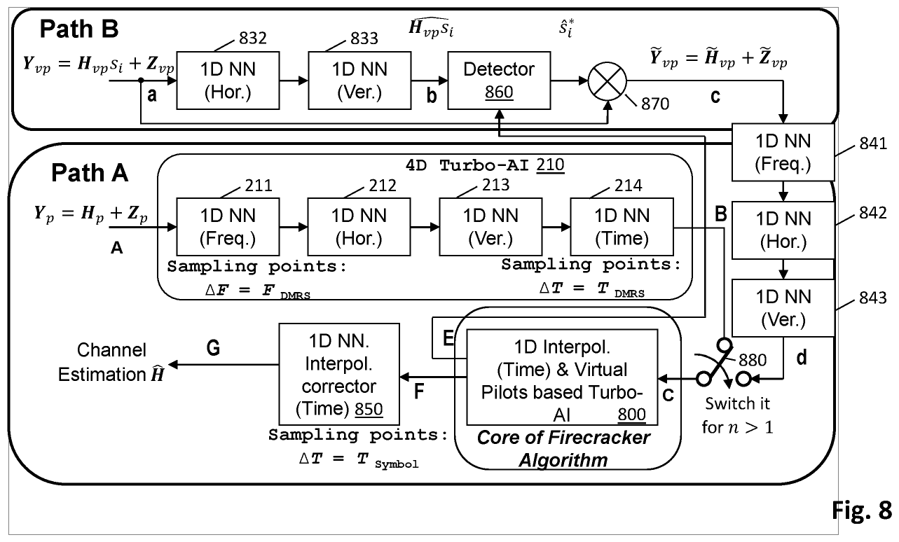

FIG. 8 illustrates introduction of virtual pilots for DMRS-Turbo-AI with 1D interpolation in time domain according to at least some example embodiments.

Path B shown in FIG. 8 processes consecutive signals Yᵥₚ=Hᵥₚsᵢ+Zᵥₚ (also referred to in this application as third signals) associated with data tones transmitted by the transmitter side antenna array between DMRS pilot tones in time domain within one frame.

The signals Yᵥₚ are 4D tensors, similarly as described above with respect to FIG. 2.

In particular, the 4D tensor Yᵥₚ (the received third signal) is projected to 1D data for horizontal domain which is input (denoted by “a”) into 1D NN 832 which was trained for channel estimation in horizontal domain using signals associated with the data tones and a correct channel estimate for horizontal domain hₕ as label. The 1D NN 832 outputs a channel estimate for horizontal domain. Then, the 1D data is transformed back to the 4D tensor.

Subsequently, the 4D tensor is projected to 1D data for vertical domain which is input into 1D NN 833 which was trained for channel estimation in vertical domain using signals associated with the data tones and a correct channel estimate for vertical domain hᵥ as label. The 1D NN 833 outputs a channel estimate for vertical domain. The channel estimations output from 1D NN 832 and 1D NN 833 are combined to a channel estimation (Hᵥₚsᵢ)\hat{ } (denoted as “b”) which corresponds to a product of a channel estimate for the received third signal and a symbol. For example, the 1D NN 832 and 1D NN 833 belong to a third group of neural network models trained for channel estimation based on data tones as described with reference to FIG. 4.

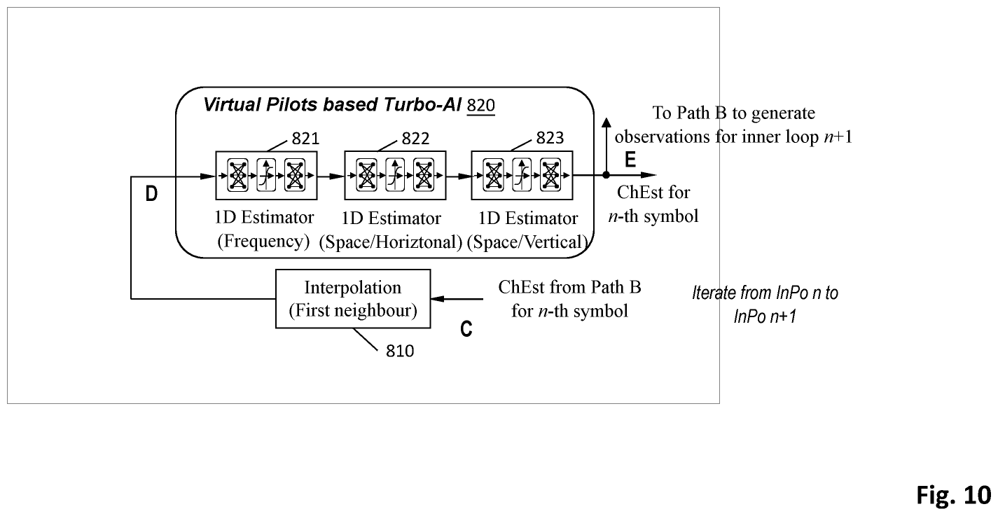

A detector 860 detects the symbol as sᵢ*\hat{ }. Referring to the description of FIG. 4, the symbol is detected based on the corrected interpolated channel estimate generated for the second signal which corresponds, in time domain, to the received third signal. In this case, according to at least some example embodiments, a channel estimation output from 1D interpolator 800 is input to NNs of the second group (not shown in FIG. 8, but shown as 1D estimators 821, 822 and 823 in FIG. 10 to be described later on) which comprise 1D NNs for frequency and spatial domains.

By a multiplication operation 870, the detected symbol is removed from the product, thereby generating a fourth signal associated with a virtual pilot tone, i.e. a signal Y\tilde{ }ᵥₚ=H\tilde{ }ᵥₚ+Z\tilde{ }ᵥₚ, denoted as “c”. This fourth signal or a representation thereof is input into each neural network model 841, 842 and 843 of a fourth group trained for channel estimation using signals associated with the virtual pilot tone which is a data aided virtual pilot tone, and a channel estimate for the second signal is generated. This channel estimate is denoted as “d”.

After having performed the 1D interpolation for the channel estimate (denoted as “B”) for the received first signal similarly as the 1D interpolator 240 of FIG. 3, the 1D interpolator 800 performs the one-dimensional interpolation in time domain for another second signal based on the channel estimate (denoted as “d”) for the second signal, by a switch operation 880 of connecting channel estimate “d” to input “C” of the 1D interpolator 800 when n>1, instead of connecting channel estimate “B” output from the 4D Turbo-AI 210 based on first signal “A” when n=1.

Based on channel estimate “d” for the second signal, the 1D interpolator 800 generates an interpolated channel estimate for the other second signal, e.g. a first neighbor of the second signal in time domain.

The interpolated channel estimate for the other second signal also is input into each neural network model of the second group shown for example as 1D estimators 821 to 823 in FIG. 10, and a corrected interpolated channel estimate for the other second signal is generated. “E” denotes the corrected interpolated channel estimate for the second signal (or the other second signal), which represents a discrete estimate for a virtual pilot tone, which is output from the 1D interpolator 800 and is fed to the detector 860.

Discrete estimates for consecutive virtual pilots tones, denoted as “F”, are input to an NN-based interpolation corrector 850, which has been trained for interpolation errors in time domain, with sampling points ΔT=T_{symbol}. The NN-based interpolation corrector 850 outputs a final channel estimation H\hat{ }, denoted as “G” (which is also referred to in this application as post-processed channel estimate).

As illustrated in FIG. 8, after being detected by the detector 860, the virtual pilot tones will be forwarded to serve as observations between the sparse DMRS pilots and improve the interpolation in time domain and the overall performance of DMRS-Turbo-AI.

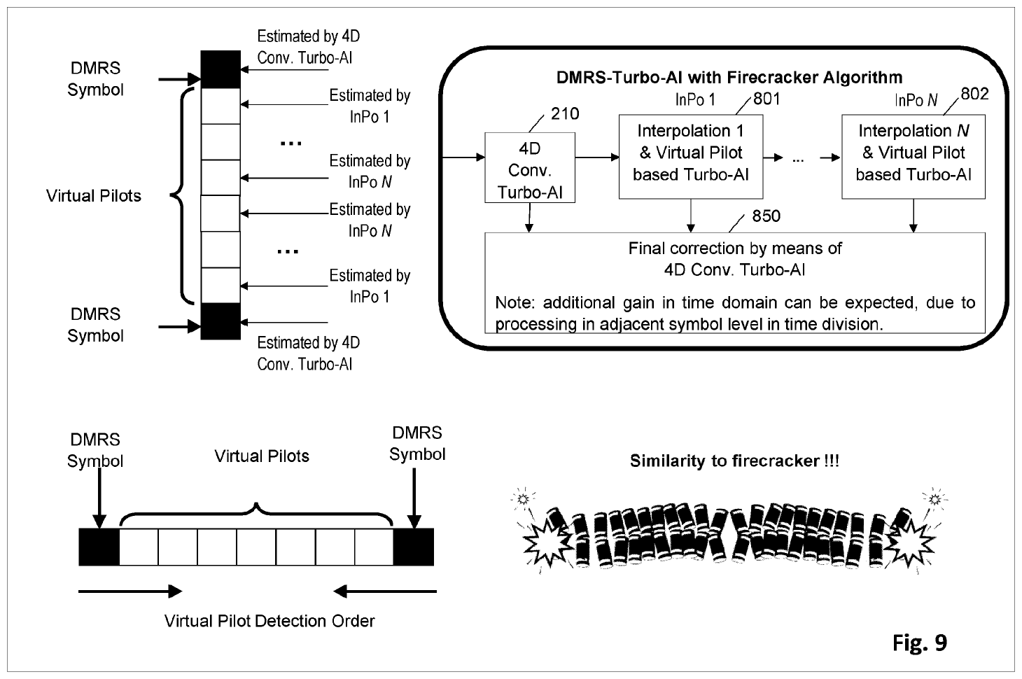

In FIG. 9, more details of Firecracker Algorithm are provided. As shown in FIG. 9, an estimated DMRS symbol estimated by the 4D Turbo-AI 210 is input to interpolation 1 801 and to the final correction by the 1D NN 850. Based on interpolation 1 801, a virtual pilot tone is estimated using the estimated DMRS symbol, and is input to a next interpolation and to the final correction by the 1D NN 850. This is repeated until interpolation N 802 which is used to estimates a virtual pilot tone N based on an estimated virtual pilot tone N−1 estimated using an interpolation N−1.

It is noted that only one symbol is detected within n-th inner loop, which is regarded as the “first neighbor” of the symbol estimated within (n−1)-th inner loop. The reason for such operation comes from the observation, where the quality of linear interpolation of the “first neighbor” turns out to be adequate due to the not varnishing correlation to the reliable estimates from the previous inner loop. Hence, this characteristic is the guarantee of Firecracker Algorithm to be relatively user mobility independent, and makes Firecracker Algorithm become an art of universal interpolator, differentiating to many existing interpolation approaches.

In particular, according to at least some example embodiments, at least two DMRS pilots are required to carry out the Firecracker Algorithm to estimate the channel response for date tones in between. The one-dimensional interpolation (denoted by reference sign 810 in FIG. 10, for example) is based on a linear interpolation which is not NN model based. For each loop in the Firecracker Algorithm, the interpolation for the adjacent symbol nearby the estimation of last loop is trusted. For example, in Loop 1, the interpolation is based on two DMRS pilots, and the interpolation values for both symbols, marked with “InPo 1”, which are First Neighbor, are accepted. In Loop 2, the interpolation is based on the channel estimates exactly for both symbols, marked with “InPo 1”, and again, the interpolation values for symbols “InPo 2” (not marked in the figures) are accepted, until N loops have been run and the channel estimation for all 2N data tones in between the DMRS pilots have been obtained.

As a matter of fact, the purpose of one-dimensional interpolation is not interpolation itself, but trying to reliably extract the virtual pilots. Once the virtual pilots are precisely recovered, the NN-models can guarantee the channel estimation quality with conventional Turbo-AI. This is also the reason why the performance is not dependent/sensitive to mobility anymore.

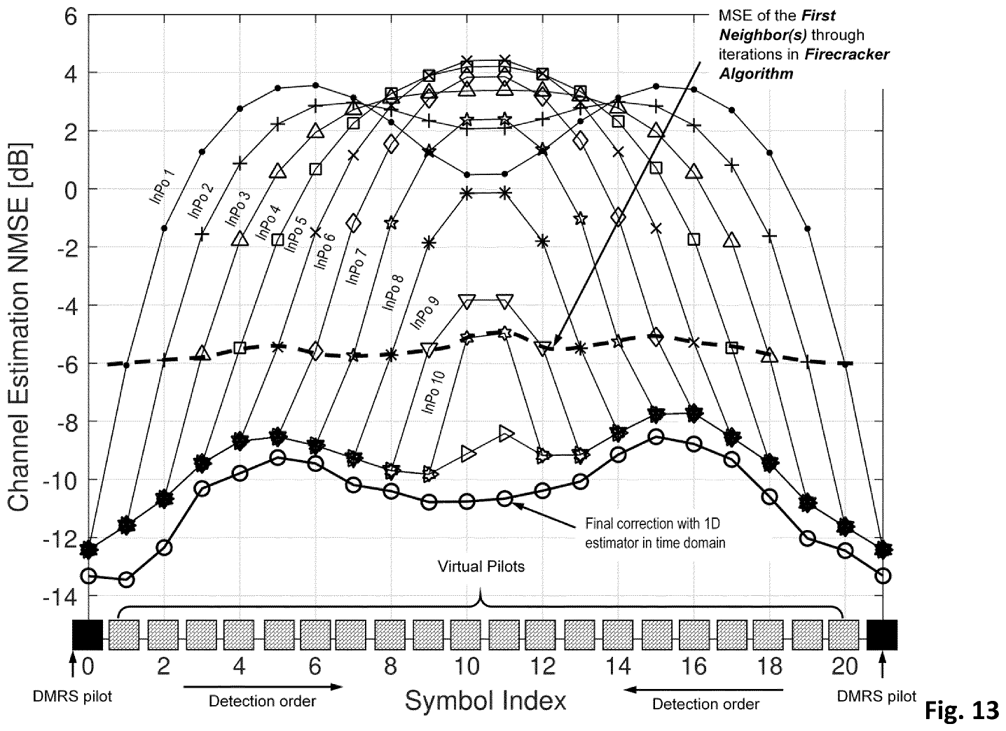

For the perfection of academic work, fundamentally, each virtual pilot tone in Firecracker Algorithm should be dedicatedly trained due to the fact that they are assumed to be corrupted by different noise after interpolation. Nevertheless, we observe in FIG. 13 to be described later on that the MSE after the linear interpolation turns out to be quite stable at 0 dB SNR. And this could be certainly guaranteed for higher SNR, which can be regarded as typical exploitation scenario of DMRS-based data transmission. Thus, from the practical NN implementation viewpoint, it is possible to train a universal NN-model, which can deal with the noise on that level.

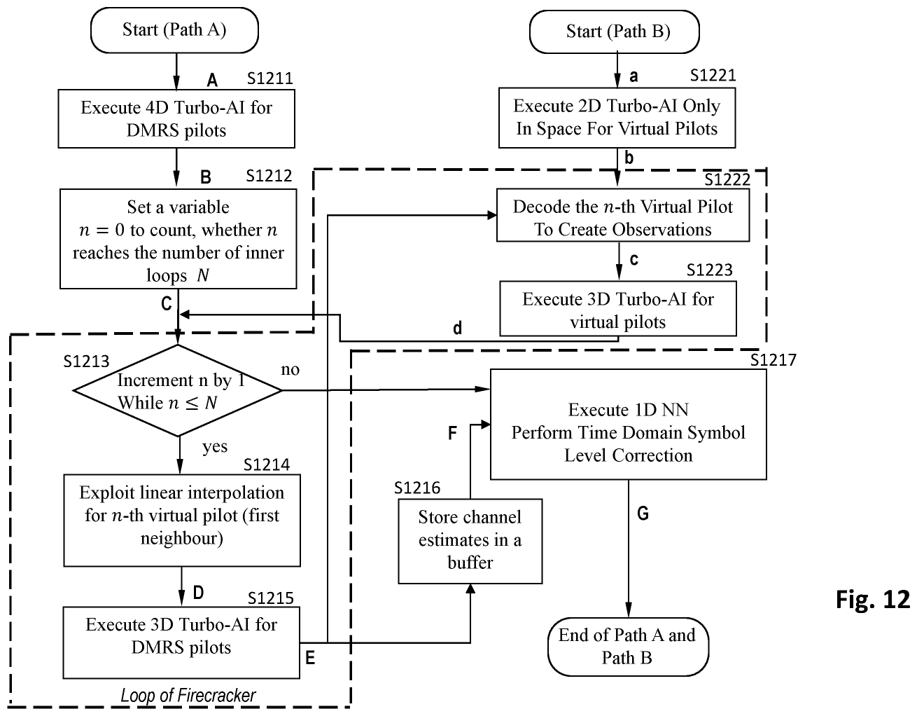

FIG. 10 illustrates a universal NN-model to realize Firecracker Algorithm according to at least some example embodiments. As shown in FIG. 10, a channel estimate from Path B for n-th symbol is input (denoted as “C”) to interpolation 810 which is part of the 1D interpolator 800 of FIG. 8. An output of interpolation 810 (denoted as “D”) is input to virtual pilots based Turbo-AI 820 which is part of the 1D interpolator 800 and comprises 1D estimators 821, 822, 823 respectively trained for channel estimation in presence of interpolation errors based on the data tones (e.g. a data-aided virtual pilot tone in Path B) in frequency, horizontal and vertical domains. The virtual pilots based Turbo-AI 820 outputs (denoted as “E”) a corrected interpolated channel estimate for n-th symbol which is fed to Path B to generate observations for inner loop n+1, and e.g. is stored in a buffer before being fed (denoted as “F” in FIGS. 8 and 12) to the 1D NN interpolation corrector 850. The flow illustrated in FIG. 10 is iterated from interpolation n to interpolation n+1 for n<=N.

As shown in FIG. 10, after estimating the channel coefficient based on n-th virtual pilot symbol, its adjacent “first neighbor” at (n+1)-th virtual pilot symbol is linearly interpolated. It is noted that the new observations for (n+1)-th inner loop were created after the channel being estimated during n-th inner loop. Then, this procedure will be repeated for all channel coefficients of 2N virtual pilot tones. Finally, the final correction will be carried out in time domain, based on adjacent symbols 1 to 2N.

It is further noted that, according to at least some example embodiments, the NNs in FIG. 10 have 2-layer DNN structure.

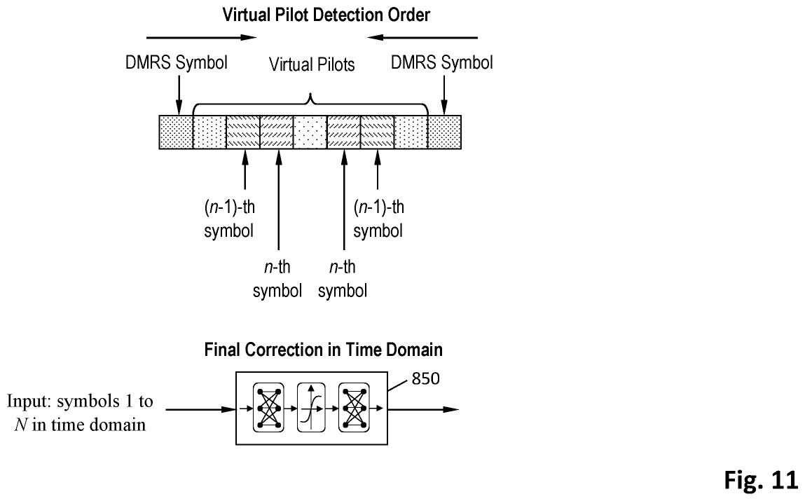

FIG. 11 illustrates a virtual pilot detection order from DMRS symbols to n-th virtual pilot symbols. FIG. 11 also shows final correction in time domain using 1D NN interpolation corrector 850 for symbols 1 to 2N.

FIG. 12 illustrates a process of ML-based channel estimation for a receiver side antenna array according to at least some example embodiments.

When Path A as illustrated in FIG. 8 is started, the process of Path A proceeds to step S1211 in which 4D Turbo-AI for DMRS pilot tones is executed for signal “A” shown in FIG. 8. The 4D Turbo-AI for DMRS pilot tones generates signal “B” shown in FIG. 8. Then, the process proceeds to step S1212.

In step S1212, a variable n is set to 0 to count whether n reaches a number of inner loops N. Then, the process proceeds to step S1213 which is part of a loop of the Firecracker Algorithm into which signal “C” shown in FIG. 8 is input. The loop of the Firecracker Algorithm comprises steps S1213, S1214, S1215, S1222 and S1223.

In step S1213, n is incremented by 1 and it is checked whether or not n is equal to or smaller than N. If “yes” in S1213, the process proceeds to step S1214. Otherwise, the process proceeds to step S1217.

In step S1214, when n=1, signal “C” corresponds to signal “B”, and a linear interpolation for an n-th virtual pilot tone which is a first neighbor of the DMRS pilot tone received as signal “A” is executed, thereby generating a signal “D” as shown in FIG. 10. Then, the process proceeds to step S1215.

In step S1215, 3D Turbo-AI for DMRS pilots is executed on signal “D”, thereby generating signal “E” as shown in FIG. 10. From step S1215, the process proceeds to step S1216 to store signal “E” as a channel estimate in a buffer. Further, from step S1215, the process proceeds to step S1222.

When starting Path A, also Path B is started upon which the process of Path B proceeds to step S1221 in which 2D Turbo-AI is executed only in space for virtual pilot tones for signal “a” shown in FIG. 8, thereby generating signal “b” shown in FIG. 8. Then, the process proceeds to step S1222.

In step S1222, the n-th virtual pilot tone is decoded with help of signal “E” output from step S1215, thereby generating signal “c” shown in FIG. 8. Then, the process proceeds to step S1223.

In step S1223, 3D Turbo-AI for virtual pilot tones is executed on signal “c”, thereby generating signal “d” shown in FIG. 8. Then, the process proceeds to step S1213.

In step S1213, n is incremented by 1 and it is checked whether or not n is equal to or smaller than N. If “yes” in S1213, the process proceeds to step S1214. Otherwise, the process proceeds to step S1217.

In step S1214, when n>1, signal “C” corresponds to signal “d”, and a linear interpolation for an n-th virtual pilot tone which is a first neighbor of the (n−1)-th virtual pilot tone received as signal “a” is executed, thereby generating a signal “D” as shown in FIG. 10. Then, the process proceeds to step S1215.

In step S1215, 3D Turbo-AI for DMRS pilots is executed on signal “D”, thereby generating signal “E” as shown in FIG. 10. From step S1215, the process proceeds to step S1216 to store signal “E” as a channel estimate in a buffer. Further, from step S1215, the process proceeds to step S1222.

The above process is repeated until n reaches N in step S1213. Then, the process proceeds to step S1217 in which the 1D NN interpolation corrector 850 performs time domain symbol level correction on signal “F” shown in FIG. 8, output from the buffer which has stored the channel estimates “E” in step S1216. Thereby, the 1D NN interpolation corrector 850 outputs signal “G” shown in FIG. 8. Then, the process of paths A and B ends.

For the simulations illustrated in FIG. 13, normalized Mean Squared Error is used as the loss function. The learning rate has been chosen to be 0.003 for Adam optimizer with decay factor of 1e−6. In every training phase the training has been stopped (early stopping) after 15 iterations.

In FIG. 13, a snapshot from a link level simulation at 0 dB SNR is used to visualize how Firecracker Algorithm improves the channel estimation NMSE, following the detection order. The black dash line indicates the channel estimation NMSE after linear interpolation with respect to the “first neighbor” for each inner loop. The same procedure will be repeated to improve the channel estimate with the recovered virtual pilot tones and Turbo-AI, until all inner loops are processed. Finally, the 1D NN interpolation corrector in time domain 850 will carry out the final correction, which has the same NN structure as a 2-layer DNN. The additional channel estimation gain comes from the fact that the samples, feed to the 1D NN interpolation corrector 850, are based on symbol level T_{symbol}. Thus, high correlations can be exploited to improve the channel estimation further.

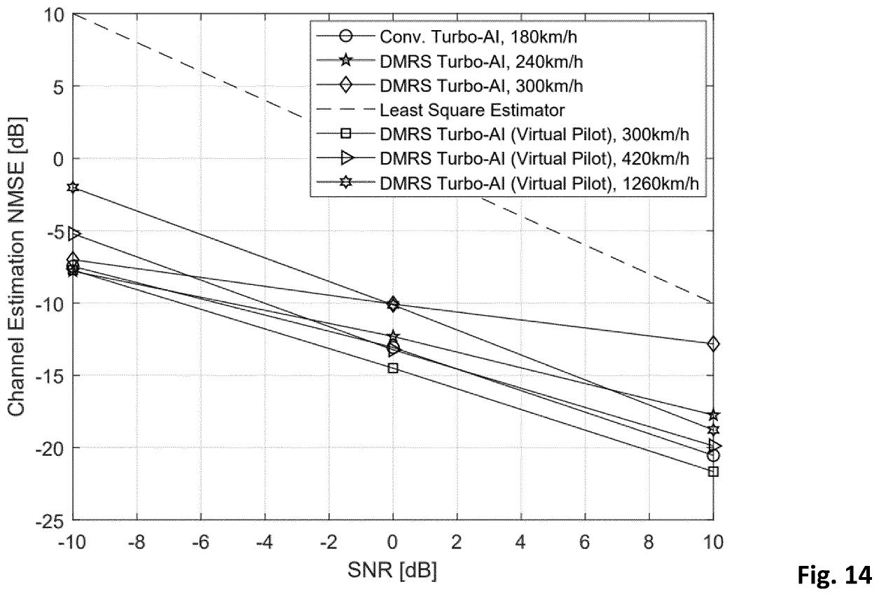

FIG. 14 shows a complete picture of channel estimation performance with DMRS-Turbo-AI and Firecracker Algorithm, which fundamentally improves that in FIG. 5. If we focus on relatively high SNR region, e.g. SNR at 10 dB, the DMRS-Turbo-AI with Firecracker Algorithm can deliver very similar performance for users with different mobility. We also observe that the sparse pilots based DMRS-Turbo-AI (curve) can conditionally outperform consecutive pilots based conventional Turbo-AI (o curve), which is a direct evidence to illustrate the effectiveness of the NN, performing final correction in time domain, as shown in FIG. 8 to FIG. 13.

As described above, according to at least some example embodiments, a part of data is selected explicitly from certain REs, which can serve as virtual pilot tones for initial interpolation. With Firecracker Algorithm and ML-based interpolation corrector, the channel estimation for all data REs, based on initial interpolation, can be improved and reach high quality.

According to at least some example embodiments, the Firecracker Algorithm alternatively or in addition is used in frequency domain, the virtual pilots being “stacked” through consecutive subcarriers in frequency domain.

According to at least some example embodiments, for single layer communications, by the transmitter-side antenna array, at least two pilot tones are transmitted within one frame in time domain, and the virtual pilot tones are transmitted between the pilot tones in time domain within the frame.

According to at least some example embodiments, alternatively or in addition, for single layer communications, by the transmitter-side antenna array, at least two pilot tones are transmitted within one frame in frequency domain, and the virtual pilot tones are transmitted, e.g. through consecutive subcarriers, between the pilot tones in frequency domain within the frame.

### Subcase B2:

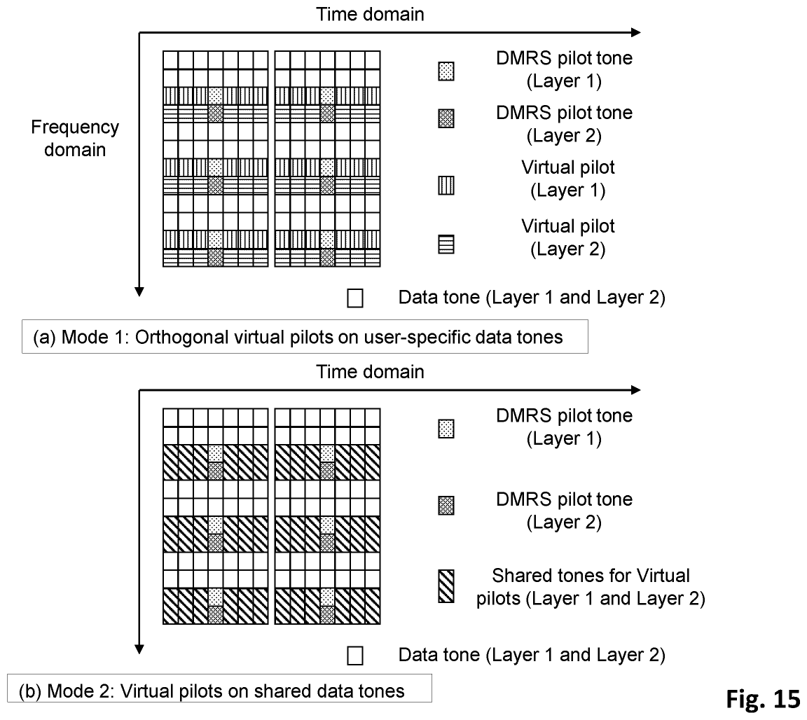

Finally, extending the method illustrated in FIGS. 8 to 12 is extended to multiple layer communications. As illustrated in FIG. 15, a DMRS and data pattern is extended for two-layer communications. In Mode 1, besides user-specific DMRS pilot tones, data-aided virtual pilot tones have to be user-specific, too. Namely, for layer 1 arbitrary data symbols are allowed on the virtual pilot positions of layer 1 (indicated by [symbol] ), and blank data symbols on the virtual pilot positions of layer 2 (indicated by [symbol] ). For layer 2 this will be vice versa.

According to at least some example embodiments, for two-layer communications, by the transmitter-side antenna array, for each layer, at least two pilot tones are transmitted in time domain, and the virtual pilot tones are transmitted for each layer between the pilot tones for each layer in time domain. Alternatively or in addition, according to at least some example embodiments, for two-layer communications, by the transmitter-side antenna array, for each layer, at least two pilot tones are transmitted in frequency domain, and the virtual pilot tones are transmitted, e.g. through consecutive subcarriers, between the pilot tones for each layer in frequency domain.

In Mode 2, according to at least some example implementations, the virtual pilot tones are shared by two layers. According to at least some example implementations, they are orthogonal cover codes, protected by CDM for virtual pilots, by carrying out dispreading to resolve the virtual pilots for both layers. Alternatively, according to at least some example implementations, they are any current standard compliant data formats, by introducing a multiuser detector, e.g. through spatial domain, to resolve the virtual pilots for Firecracker Algorithm for each layer individually.

According to at least some example embodiments, for two-layer communications, by the transmitter-side antenna array, for each layer, at least two pilot tones are transmitted in time domain, and the virtual pilot tones are transmitted for both layers between the pilot tones for each layer in time domain. Alternatively or in addition, according to at least some example embodiments, for two-layer communications, by the transmitter-side antenna array, for each layer, at least two pilot tones are transmitted in frequency domain, and the virtual pilot tones are transmitted for both layers, e.g. through consecutive subcarriers, between the pilot tones for each layer in frequency domain.

According to at least some example implementations, just one set of NN-models to adapt to many possible user speeds in DMRS-Turbo-AI with Firecracker Algorithm has to be created, which provides for an enormous relaxation for hardware implementation.

In the above description, the DMRS pilot structure is fixed. However, this is not construed to be limiting. According to at least some example embodiments, for a user with a given speed, different DMRS pilot structures are used, by tuning the DMRS sparsity. Such “Adaptive Pilot” is an additional option for adjusting the data throughput.

That is, according to at least some example embodiments, number and arrangement of pilot tones in the frames as shown e.g. in FIGS. 6 and 15 is changed in accordance with a moving speed of the transmitter side antenna array.

The Firecracker Algorithm then also is capable of delivering robust performance.

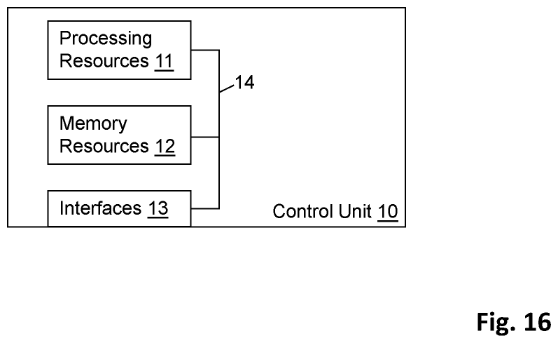

Now reference is made to FIG. 16 illustrating a simplified block diagram of a control unit 10 that is suitable for use in practicing at least some example embodiments. According to an implementation example, the method of FIG. 4 is implemented by the control unit 10.

The control unit 10 comprises processing resources (e.g. processing circuitry) 11, memory resources (e.g. memory circuitry) 12 and interfaces (e.g. interface circuitry) 13, which are coupled via a wired or wireless connection 14.

According to at least some example implementations, the memory resources 12 are of any type suitable to the local technical environment and are implemented using any suitable data storage technology, such as semiconductor based memory devices, magnetic memory devices and systems, optical memory devices and systems, fixed memory and removable memory. The processing resources 11 are of any type suitable to the local technical environment, and include one or more of general purpose computers, special purpose computers, microprocessors, digital signal processors (DSPs) and processors based on a multi core processor architecture, as non-limiting examples.

According to at least some example implementations, the memory resources 12 comprise one or more non-transitory computer-readable storage media which store one or more programs that when executed by the processing resources 11 cause the control unit 10 to perform the method shown in FIG. 4 or to function as the processes of Path A and Path B as described above.

According to at least some example implementations, the interfaces comprise transceivers which include both transmitter and receiver, and inherent in each is a modulator/demodulator commonly known as a modem.

In general, at least some example embodiments are implemented in hardware or special purpose circuits, software (computer readable instructions embodied on a computer readable medium), logic or any combination thereof.

Further, as used in this application, the term “circuitry” refers to one or more or all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

According to at least some example embodiments, an apparatus for channel estimation for a receiver side antenna array is provided. The apparatus comprises means for receiving a first signal associated with a pilot tone transmitted by a transmitter side antenna array, means for obtaining a first group of neural network models trained for channel estimation based on the pilot tone, means for inputting a representation of the received first signal into each neural network model of the first group and generating a channel estimate for the received first signal, means for, based on the channel estimate for the received first signal, performing one-dimensional interpolation for second signals associated with data tones in at least one of time domain and frequency domain, thereby generating interpolated channel estimates for the second signals, which include interpolation errors, means for obtaining a second group of neural network models trained for channel estimation in presence of interpolation errors based on the data tones, and means for, for each one-dimensional interpolation, inputting an interpolated channel estimate of the generated interpolated channel estimates into each neural network model of the second group and generating a corrected interpolated channel estimate for a second signal.

According to at least some example embodiments, the apparatus further comprises means for, for each one-dimensional correction, inputting the corrected interpolated channel estimate into the at least one neural network model and generating a post-processed channel estimate for the second signal, wherein the at least one neural network model comprises at least one of a neural network model trained for channel estimation in presence of the interpolation errors based on the pilot tone in time domain and a neural network model trained for channel estimation in presence of the interpolation errors based on the pilot tone in frequency domain.

According to at least some example embodiments, the neural network models of the first group comprise neural network models for frequency, spatial and time domains, and the neural network models of the second group comprise at least neural network models for spatial domain.

According to at least some example embodiments, the apparatus further comprises means for receiving, in at least one of time domain and frequency domain, consecutive third signals associated with data tones transmitted by the transmitter side antenna array, means for obtaining a third group of neural network models trained for channel estimation based on the data tones, means for obtaining a fourth group of neural network models trained for channel estimation based on a data aided virtual pilot tone, and means for, for each third signal of the received third signals, inputting a representation of the received third signal into each neural network model of the third group, and generating a product of a channel estimate for the received third signal and a symbol, detecting the symbol based on the corrected interpolated channel estimate generated for the second signal which corresponds, in at least one of time domain and frequency domain, to the received third signal, removing the detected symbol from the product, thereby generating a fourth signal associated with the data aided virtual pilot tone, inputting a representation of the fourth signal into each neural network model of the fourth group and generating a channel estimate for the second signal, based on the channel estimate for the second signal, performing the one-dimensional interpolation in at least one of time domain and frequency domain for another second signal, thereby generating an interpolated channel estimate for the other second signal, and inputting the interpolated channel estimate for the other second signal into each neural network model of the second group, and generating a corrected interpolated channel estimate for the other second signal.

According to at least some example embodiments, the second group comprises plural sets of the neural network models separately trained for each one-dimensional interpolation, wherein each of the plural sets is used to correct the interpolated channel estimate for the one-dimensional interpolation for which it has been trained.

According to at least some example embodiments, the neural network models of the second group are trained for each of the one-dimensional interpolations and are used to correct each of the interpolated channel estimates.

According to at least some example embodiments, the apparatus further comprises means for repeating the one-dimensional interpolation N times for N+N second signals between two first signals, thereby obtaining corrected interpolated channel estimates associated with each of data tones between two adjacent pilot tones.

According to at least some example embodiments, the apparatus further comprises means for obtaining at least one neural network model trained for channel estimation in presence of the interpolation errors based on the pilot tone, and means for inputting the obtained corrected interpolated channel estimates into the at least one neural network model and generate post-processed channel estimates for the second signals, wherein the at least one neural network model comprises at least one of a neural network model trained for channel estimation in presence of the interpolation errors based on the pilot tone in time domain and a neural network model trained for channel estimation in presence of the interpolation errors based on the pilot tone in frequency domain.

According to at least some example embodiments, the neural network models of the first group comprise neural network models for frequency, spatial and time domains, the neural network models of the second group comprise neural network models at least for spatial domains, the neural network models of the third group comprises neural network model for spatial domain, and the neural network models of the fourth group comprise neural network models at least for spatial domains.

It is to be understood that the above description is illustrative and is not to be construed as limiting. Various modifications and applications may occur to those skilled in the art without departing from the true spirit and scope as defined by the appended claims.

1. A method of channel estimation for a receiver side antenna array, the method comprising:
receiving a first signal associated with a pilot tone transmitted by a transmitter side antenna array;
obtaining a first group of neural network models trained for channel estimation based on the pilot tone;
inputting a representation of the received first signal into each neural network model of the first group and generating a channel estimate for the received first signal;
based on the channel estimate for the received first signal, performing one-dimensional interpolation for second signals associated with data tones in at least one of time domain and frequency domain, thereby generating interpolated channel estimates for the second signals, which include interpolation errors;
obtaining a second group of neural network models trained for channel estimation in presence of interpolation errors based on the data tones; and
for each one-dimensional interpolation, inputting an interpolated channel estimate of the generated interpolated channel estimates into each neural network model of the second group and generating a corrected interpolated channel estimate for a second signal.

2. The method of claim 1, further comprising:
obtaining at least one neural network model trained for channel estimation in presence of the interpolation errors based on the pilot tone; and
for each one-dimensional correction, inputting the corrected interpolated channel estimate into the at least one neural network model and generating a post-processed channel estimate for the second signal,
wherein the at least one neural network model comprises at least one of a neural network model trained for channel estimation in presence of the interpolation errors based on the pilot tone in time domain and a neural network model trained for channel estimation in presence of the interpolation errors based on the pilot tone in frequency domain.

3. The method of claim 1, wherein the neural network models of the first group comprise neural network models for frequency, spatial and time domains, and the neural network models of the second group comprise at least neural network models for spatial domain.

4. The method of claim 1, further comprising:
receiving, in at least one of time domain and frequency domain, consecutive third signals associated with data tones transmitted by the transmitter side antenna array;
obtaining a third group of neural network models trained for channel estimation based on the data tones;
obtaining a fourth group of neural network models trained for channel estimation based on a data aided virtual pilot tone;
for each third signal of the received third signals:
inputting a representation of the received third signal into each neural network model of the third group, and generating a product of a channel estimate for the received third signal and a symbol;
detecting the symbol based on the corrected interpolated channel estimate generated for the second signal which corresponds, in at least one of time domain and frequency domain, to the received third signal;
removing the detected symbol from the product, thereby generating a fourth signal associated with the data aided virtual pilot tone;
inputting a representation of the fourth signal into each neural network model of the fourth group and generating a channel estimate for the second signal;
based on the channel estimate for the second signal, performing the one-dimensional interpolation in at least one of time domain and frequency domain for another second signal, thereby generating an interpolated channel estimate for the other second signal; and
inputting the interpolated channel estimate for the other second signal into each neural network model of the second group, and generating a corrected interpolated channel estimate for the other second signal.

5. The method of claim 4, wherein the second group comprises plural sets of the neural network models separately trained for each one-dimensional interpolation, wherein each of the plural sets is used to correct the interpolated channel estimate for the one-dimensional interpolation for which it has been trained.

6. The method of claim 4, wherein the neural network models of the second group are trained for each of the one-dimensional interpolations and are used to correct each of the interpolated channel estimates.

7. The method of claim 4, wherein the one-dimensional interpolation is repeated N times for N+N second signals between two first signals, thereby obtaining corrected interpolated channel estimates associated with each of data tones between two adjacent pilot tones.

8. The method of claim 7, further comprising:
obtaining at least one neural network model trained for channel estimation in presence of the interpolation errors based on the pilot tone; and
inputting the obtained corrected interpolated channel estimates into the at least one neural network model and generating post-processed channel estimates for the second signals,
wherein the at least one neural network model comprises at least one of a neural network model trained for channel estimation in presence of the interpolation errors based on the pilot tone in time domain and a neural network model trained for channel estimation in presence of the interpolation errors based on the pilot tone in frequency domain.

9. The method of claim 4, wherein the neural network models of the first group comprise neural network models for frequency, spatial and time domains, the neural network models of the second group comprise neural network models at least for spatial domains, the neural network models of the third group comprises neural network model for spatial domain, and the neural network models of the fourth group comprise neural network models at least for spatial domains.

10. The method of claim 4, wherein, for single layer communications, by the transmitter-side antenna array, at least two pilot tones are transmitted within one frame in time domain, and the virtual pilot tones are transmitted between the pilot tones in time domain within the frame.

11. The method of claim 4, wherein, for single layer communications, by the transmitter-side antenna array, at least two pilot tones are transmitted within one frame in frequency domain, and the virtual pilot tones are transmitted between the pilot tones in frequency domain within the frame.

12. The method of claim 4, wherein, for two-layer communications, by the transmitter-side antenna array, for each layer, at least two pilot tones are transmitted in time domain, and the virtual pilot tones are transmitted for each layer between the pilot tones for each layer in time domain.

13. The method of claim 4, wherein, for two-layer communications, by the transmitter-side antenna array, for each layer, at least two pilot tones are transmitted in frequency domain, and the virtual pilot tones are transmitted between the pilot tones for each layer in frequency domain.

14. The method of claim 4, wherein, for two-layer communications, by the transmitter-side antenna array, for each layer, at least two pilot tones are transmitted in time domain, and the virtual pilot tones are transmitted for both layers between the pilot tones for each layer in time domain.

15. The method of claim 4, wherein, for two-layer communications, by the transmitter-side antenna array, for each layer, at least two pilot tones are transmitted in frequency domain, and the virtual pilot tones are transmitted for both layers between the pilot tones for each layer in frequency domain.

16. The method of claim 14, wherein the virtual pilot tones shared by the two layers are orthogonal cover codes.

17. The method of claim 10, wherein number and arrangement of pilot tones in the frames is changed in accordance with a moving speed of the transmitter side antenna array.

18. A non-transitory computer-readable storage medium storing a program for channel estimation for a receiver side antenna array that, when executed by a computer, causes the computer at least to:
receive a first signal associated with a pilot tone transmitted by a transmitter side antenna array;
obtain a first group of neural network models trained for channel estimation based on the pilot tone;
input a representation of the received first signal into each neural network model of the first group and generate a channel estimate for the received first signal;
based on the channel estimate for the received first signal, perform one-dimensional interpolation for second signals associated with data tones in at least one of time domain and frequency domain, thereby generating interpolated channel estimates for the second signals, which include interpolation errors;
obtain a second group of neural network models trained for channel estimation in presence of interpolation errors based on the data tones; and
for each one-dimensional interpolation, input an interpolated channel estimate of the generated interpolated channel estimates into each neural network model of the second group and generate a corrected interpolated channel estimate for a second signal.

19. An apparatus for channel estimation for a receiver side antenna array, the apparatus comprising at least one processor and at least one memory including computer program code, the at least one memory and the computer program code configured to, with the at least one processor, cause the apparatus at least to:
receive a first signal associated with a pilot tone transmitted by a transmitter side antenna array;
obtain a first group of neural network models trained for channel estimation based on the pilot tone;
input a representation of the received first signal into each neural network model of the first group and generate a channel estimate for the received first signal;
based on the channel estimate for the received first signal, perform one-dimensional interpolation for second signals associated with data tones in at least one of time domain and frequency domain, thereby generating interpolated channel estimates for the second signals, which include interpolation errors;
obtain a second group of neural network models trained for channel estimation in presence of interpolation errors based on the data tones; and
for each one-dimensional interpolation, input an interpolated channel estimate of the generated interpolated channel estimates into each neural network model of the second group and generate a corrected interpolated channel estimate for a second signal.

20.-27. (canceled)
